(19) United States
(12) Patent Application Publication
(10) Pub. No.: US 2025/0045885 A1
(43) Pub. Date: Feb. 6, 2025

(54) METHOD FOR IMAGE ENHANCEMENT IN AN IMAGING DATASET OF AN OBJECT COMPRISING INTEGRATED CIRCUIT PATTERNS AND CORRESPONDING COMPUTER PROGRAM, COMPUTER-READABLE MEDIUM AND SYSTEM

(71) Applicant: Carl Zeiss SMT GmbH, Oberkochen (DE)

(72) Inventor: Martin Van Driel, Muenchen (DE)

(21) Appl. No.: 18/792,766

(22) Filed: Aug. 2, 2024

(30) Foreign Application Priority Data
Aug. 4, 2023 (DE) 102023120813.6

(51) Int. Cl. G06T 5/70; G06T 5/20; G06T 5/60; G06T 7/00

(52) U.S. Cl. CPC G06T 5/70; G06T 5/20; G06T 5/60; G06T 7/001; G06T 2207/20081; G06T 2207/20084; G06T 2207/30148

(57) ABSTRACT

The invention relates to a method for defect detection comprising: acquiring an imaging dataset of an object comprising integrated circuit patterns using an imaging system; obtaining a reference dataset corresponding to the acquired imaging dataset; generating an enhanced imaging dataset by filtering the acquired imaging dataset with one or more learned filters, wherein the one or more learned filters are obtained by solving an optimization problem comprising the deviation of the enhanced imaging dataset from the reference dataset; and detecting defects in the acquired imaging dataset by comparing the enhanced imaging dataset to the corresponding reference dataset. The invention also relates to a corresponding computer program, a computer-readable medium and a system for defect detection in objects comprising integrated circuit patterns.

### CROSS-REFERENCE TO RELATED APPLICATION

This application claims benefit under 35 U.S.C. § 119 (a) of German patent application 10 2023 120 813.6, filed on Aug. 4, 2023, which is incorporated herein by reference in its entirety.

### TECHNICAL FIELD

The invention relates to methods and systems for quality control and quality assurance in objects comprising integrated circuit patterns, more specifically to methods, a corresponding computer-readable medium, computer program and systems for image enhancement and defect detection with increased accuracy. The method, computer-readable medium, computer program and system can be utilized for image enhancement, quantitative metrology, defect detection, defect classification, defect localization, or defect review in objects comprising integrated circuit patterns, in particular photolithography masks, reticles, or wafers. Defect classification assigns a specific type of defect to a defect detection, e.g., extrusion, line break, etc.

### BACKGROUND

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal, and optical processes. Dimensions, shapes and placements of the semiconductor structures and patterns are subject to several influences. One of the most crucial steps is the photolithography process.

Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. The photolithography mask can be further adapted, e.g., by use of optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 10 nm, for example 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithographic masks or templates for nanoimprint photolithography with ever smaller structures or pattern elements. The production process of photolithographic masks and templates for nanoimprint photolithography is, therefore, becoming increasingly more complex and, as a result, more time-consuming and ultimately also more expensive. With the advent of EUV photolithography scanners, the nature of masks changed from transmission-based to reflection-based patterning.

On account of the tiny structure sizes of the pattern elements of photolithographic masks or templates, it is not possible to exclude errors during mask or template production. The resulting defects can, for example, arise from degeneration of photolithography masks or particle contamination. Of the various defects occurring during semiconductor structure manufacturing, photolithography related defects make up nearly half of the number of defects. Hence, in semiconductor process control, photolithography mask inspection, review, and metrology play a crucial role to monitor systematic defects. Defects detected during quality assurance processes can be used for root cause analysis, for example, to modify or repair the photolithography mask. The defects can also serve as feedback to improve the process parameters of the manufacturing process, e.g., exposure time, focus, illumination, etc.

Photolithography mask inspection needs to be done at multiple points in time in order to improve the quality of the photolithography masks and to maximize their usage cycles. Once the photolithography mask is fabricated according to the requirements, an initial quality assessment of the photolithography mask is done at the mask house before it is shipped to the wafer fab. Semiconductor device design and photolithography mask manufacturing quality are verified by different procedures before the photolithography mask enters a semiconductor fabrication facility to begin production of integrated circuits. The semiconductor device design is checked by software simulation to verify that all features print correctly after photolithography in manufacturing. The photolithography mask is inspected for defects and measured to ensure that the features are within specification. The data gathered during this process becomes the golden baseline or reference for further inspections to be performed at the mask house or wafer fab. Any defects found on the photolithography mask are validated using a review tool followed by a decision of sending the photolithography mask for repair or decommissioning the mask and ordering a new one. At the wafer fab, the photolithography mask is scanned to find additional defects called “adders” compared to the last scan performed at the mask house. Each of these adders is analyzed using a review tool. The review tool analyzes a potential defect to determine if it is a defect or not. The reviewing can be accomplished using defect detection methods, e.g., a comparison with a reference image. In case of a particle defect, the particle is removed. In case of a pattern-based defect the photolithography mask is either repaired, if possible, or replaced by a new one. The inspection process is repeated after every few photolithography cycles.

Each defect in the photolithography mask can lead to unwanted behavior of the produced wafer, or a wafer can be significantly damaged. Therefore, each defect must be found and repaired if possible and necessary. Reliable and fast defect detection methods are, therefore, important for photolithography masks.

Apart from defect detection in photolithography masks, defect detection in wafers is crucial for quality management. During the manufacturing of wafers many defects apart from photolithography mask defects can occur, e.g., during etching or deposition. For example, bridge defects can indicate insufficient etching, line breaks can indicate excessive etching, consistently occurring defects can indicate a defective mask and missing structures hint at non-ideal material deposition etc. Therefore, a quality assurance process and a quality control process are important for ensuring high quality standards of the manufactured wafers.

Defect detection in wafers is also important during process window qualification (PWQ). This process serves for defining windows for a number of process parameters mainly related to different focus and exposure conditions in order to prevent systematic defects. In each iteration a test wafer is manufactured based on a number of selected process parameters, e.g., exposure time, focus, etc., with different dies of the wafer being exposed to different manufacturing conditions. Exposure time refers to a duration of time the wafer is exposed to light. Focus refers to the position of the plane of best focus of the optical system relative to some reference plane, such as the top surface of the resist, measured along the optical axis. Exposure and focus determine the resist profiles. Resist profiles are often described by three parameters related to a trapezoidal approximation of the profile: the linewidth or critical dimension (CD), the sidewall angle, and the final resist thickness. Since the effect of focus depends on exposure, one way to judge the response of the process is to simultaneously vary both focus and exposure. The focus-exposure matrix obtained this way can easily be visualized. By detecting and analyzing the defects in the different dies based on a quality assurance process, the best manufacturing process parameters can be selected, and a window or range can be established for each process parameter from which the respective process parameter can be selected. In addition, a highly accurate quality control process and device for the metrology of semiconductor structures in wafers is required. The recognized defects can, thus, be used for monitoring the quality of wafers during production or for process window establishment.

Methods for the automatic detection of defects in objects comprising integrated circuit patterns include defect detection algorithms, which are often based on a die-to-die or die-to-database principle.

The die-to-die principle compares an imaging dataset of portions of an object with a reference dataset in the form of another imaging dataset, e.g., of the same portions of another identical object or of identical portions of the same object. The discovered deviations are treated as defects. This method requires the availability of two corresponding portions of objects and exact knowledge about their relative position. It may fail in case of repeater defects.

The die-to-database principle compares an imaging dataset of an object with a reference dataset that can be loaded from a database, e.g., a previously recorded imaging dataset or a simulated imaging dataset or a CAD file, thereby discovering deviations from the ideal data. Unexpected patterns in the imaging dataset are detected due to large differences. Repeater defects can be handled. However, a registration of the imaging dataset and the reference dataset is required.

To simplify defect detection and improve results, filtering operations can be applied to the imaging dataset. For example, the WO 2017/186421 A1 discloses a method for detecting defects in an image using a high-pass filter, assuming that defects correspond to high frequency components in the image.

However, this assumption often does not hold, since the acquired imaging dataset is subject to various effects causing systematic deviations (often of high frequency) from the expected image in case of ideal optics. Such systematic deviations include defocus, shifts, aberrations, time-delayed integration (TDI) blur, wave front errors and thermal drift. For example, shifts can occur due to the non-orthogonal lighting of the imaging system, aberrations, in particular time-dependent aberrations, can occur due to thermal variations of the mirrors in the imaging system, TDI blur can occur due to random illumination variations during image acquisition, etc. The systematic deviations lead to imaging artifacts such as color, intensity, sharpness or contrast variations, translations, blur, noise etc. During defect detection, e.g., based on a die-to-die or die-to-database method, these imaging artifacts result in many false positive defect detections. To reduce such false positive defect detections, tight system requirements have to be fulfilled in order to minimize these imaging artifacts. In addition, the imaging artifacts also lead to false negative defect detections, i.e., unrecognized defects, since the criteria for detecting defects are selected to discard as many imaging artifacts as possible and, thus, less prominent defects as well.

It is, therefore, a feature of the invention to enhance the imaging dataset such that imaging artifacts are reduced. It is a feature of the invention to enhance the imaging dataset such that defects are preserved and can be detected more easily. It is another feature of the invention to reduce false positive and false negative defect detections in imaging datasets of objects comprising integrated circuit patterns. It is another feature of the invention to improve the accuracy and specificity of defect detection methods in imaging datasets of objects comprising integrated circuit patterns. It is another feature of the invention to enhance the imaging dataset by reducing imaging artifacts. It is another feature of the invention to relax the tight system requirements during the image acquisition process without introducing a high false positive defect detection rate. A further feature of the invention is to detect defects quickly in order to optimize throughput. It is another feature of the invention to simplify the design of defect detection rules.

The features are achieved by the invention specified in the independent claims. Advantageous embodiments and further developments of the invention are specified in the dependent claims.

### SUMMARY

Embodiments of the invention concern methods, computer-readable media, computer program products and systems implementing image enhancement and defect detection methods for objects comprising integrated circuit patterns.

An integrated circuit pattern can, for example, comprise semiconductor structures. An object comprising integrated circuit patterns can refer, for example, to a photolithography mask, a reticle or a wafer. In a photolithography mask or reticle the integrated circuit patterns can refer to mask structures used to generate semiconductor patterns in a wafer during the photolithography process. In a wafer the integrated circuit patterns can refer to semiconductor structures, which are imprinted on the wafer during the photolithography process.

The object comprising integrated circuit patterns may be a photolithography mask. The photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

An embodiment of the invention involves a method for image enhancement comprising acquiring an imaging dataset of an object comprising integrated circuit patterns using an imaging system; obtaining a reference dataset corresponding to the acquired imaging dataset; generating an enhanced imaging dataset by filtering the acquired imaging dataset with one or more learned filters, wherein the one or more learned filters are obtained by solving an optimization problem comprising the deviation of the enhanced imaging dataset from the reference dataset. Optionally, the method comprises detecting defects in the acquired imaging dataset by comparing the enhanced imaging dataset to the corresponding reference dataset. The method steps for processing the acquired imaging dataset and the reference dataset can be carried out by a computer.

According to an embodiment of the invention, the method for image enhancement further comprises detecting defects in the acquired imaging dataset by comparing the enhanced imaging dataset to the reference dataset, e.g., by using the deviation in the optimization problem for the enhanced imaging dataset after optimization. The defect detection can also be carried out by a computer.

The imaging dataset can comprise one or more images of one or more portions of the object comprising integrated circuit patterns or of the whole object. According to the techniques described herein, various imaging modalities may be used to acquire the imaging dataset. Imaging datasets can comprise single-channel images or multi-channel images, e.g., focus stacks. For instance, it is possible that the imaging dataset includes 2-D images. It is possible to employ a multi beam scanning electron microscope (mSEM). mSEM employs multiple beams to acquire contemporaneously images in multiple fields of view. For instance, a number of not less than 50 beams could be used or even not less than 90 beams. Each beam covers a separate portion of a surface of the object comprising integrated circuit patterns. Thereby, a large imaging dataset is acquired within a short duration of time. Typically, contemporary machines acquire 4.5 gigapixels per second. For illustration, one square centimeter of a wafer 20 can be imaged with 2 nm pixel size leading to 25 terapixels of data. Other examples for imaging datasets including 2D images relate to imaging modalities such as optical imaging, phase-contrast imaging, x-ray imaging, etc. It would also be possible that the imaging dataset is a volumetric 3-D dataset, which can be processed slice-by-slice or as a three-dimensional volume. Here, a crossbeam imaging system including a focused-ion beam (FIB) source, an atomic force microscope (AFM) or a scanning electron microscope (SEM) could be used. Multimodal imaging datasets may be used, e.g., a combination of x-ray imaging and SEM. The imaging dataset can, additionally or alternatively, comprise aerial images acquired by an aerial imaging system. An aerial image is the radiation intensity distribution at substrate level. It can be used to simulate the radiation intensity distribution generated by a photolithography mask during the photolithography process. The aerial image measurement system can, for example, be equipped with a staring array sensor or a line-scanning sensor or a time-delayed integration (TDI) sensor.

The reference dataset of the object comprising integrated circuit patterns can also be obtained in different ways. It can comprise an acquired imaging dataset or an artificially generated imaging dataset. In an example, the reference dataset is obtained by acquiring images of a reference object comprising integrated circuit patterns. The reference object comprising integrated circuit patterns can, for example, be another instance of the same type of object, or it can be of a different type but comprising at least a portion of the same integrated circuit patterns as the object. In another example, the reference dataset is obtained from one or more portions of the (same) object comprising integrated circuit patterns, e.g., from another die of the object, for example in case of repetitive structures. In another example, the reference dataset is artificially generated. In another example, the reference dataset is obtained from simulated images of the object comprising integrated circuit patterns, e.g., from CAD files or simulated aerial images. The appearance of the simulated reference dataset can be similar to the appearance of the imaging dataset, e.g., by using a machine learning model such as a generative adversarial neural network that is trained to imitate the appearance of images. The simulated images can be loaded from a database or a memory or a cloud storage.

The term “defect” refers to a localized deviation of an integrated circuit pattern from an a priori defined norm of the integrated circuit pattern. For instance, a defect of an integrated circuit pattern, e.g., of a semiconductor structure, can result in malfunctioning of an associated semiconductor device. Depending on the detected defect, for example, the photolithography process can be improved, or photolithography masks or wafers can be repaired or discarded. The norm of the integrated circuit pattern can be defined by a corresponding reference object or dataset, e.g., a model dataset (e.g., using a CAD design) or an acquired defect-free dataset.

The term “filter” refers to a mathematical operation applied to a subset of the pixels of an imaging dataset or to the whole imaging dataset, which alters the appearance of the imaging dataset. A filter can have specific characteristics, e.g., the filter can be a linear filter, a translation invariant filter or a finite impulse response filter, a size filter modifying the image size, a sharpening filter, a contrast enhancement filter, a color filter, an edge detection filter, an edge preserving filter, a denoising filter, a compression filter, etc.

A learned filter, in contrast to a predefined filter with predefined values, is obtained from application data by solving some kind of optimization problem comprising the deviation of the enhanced imaging dataset from the reference dataset. It is, thus, obtained in a data-driven manner from the data it will be applied to, i.e. it is derived from the same imaging dataset (or a subset thereof) and corresponding reference dataset it will be applied to.

By filtering the imaging dataset with one or more learned filters, imaging artifacts due to systematic deviations caused by the imaging system can be reduced and subsequent optional defect detections can be improved. Such systematic deviations include shifts, defocus, aberrations, time-delayed integration blur, wave front errors, thermal drift, etc. The enhanced imaging dataset is better suitable for defect detection, since artifacts and, thus, false positive defect detections are reduced. In addition, defects can be localized more reliably, i.e. their location in the image can be determined more reliably, and false negative detections prevented, since criteria for finding defects in the enhanced imaging dataset can be selected with higher sensitivity. By using one or more learned filters for filtering the imaging dataset, the one or more learned filters are obtained in a data-driven manner. In this way, the design of defect detection rules is simplified. By deriving the one or more learned filters directly from the acquired imaging dataset and reference dataset, the one or more learned filters are specifically adapted to the acquired imaging dataset and reference dataset. Thus, artifacts can be most successfully removed, and defects can be detected with improved reliability. A separate set of one or more learned filters can be derived for each imaging dataset and reference dataset separately. Alternatively, the same set of one or more learned filters can be applied to multiple imaging datasets, in particular to similar imaging datasets. A learned filter can also be used as initial starting point or initial value in an optimization problem for deriving another learned filter.

Instead of applying the one or more learned filters to the imaging dataset, the one or more learned filters can be applied to the reference dataset. In this case, the one or more learned filters are used to approximate the disturbance of the reference dataset by the systematic deviations due to the imaging system.

Thus, an embodiment of the invention involves a method for image enhancement comprising: acquiring an imaging dataset of an object comprising integrated circuit patterns using an imaging system: obtaining a reference dataset corresponding to the acquired imaging dataset; generating a filtered reference dataset by filtering the reference dataset with one or more learned filters, wherein the one or more learned filters are obtained by solving an optimization problem comprising the deviation of the filtered reference dataset from the imaging dataset. Optionally, the method further comprises detecting defects in the acquired imaging dataset by comparing the filtered reference dataset to the imaging dataset. The method steps for processing the reference dataset and the imaging dataset can be carried out by a computer.

According to an embodiment of the invention, the method for image enhancement further comprises detecting defects in the acquired imaging dataset by comparing the filtered reference dataset to the imaging dataset, e.g., by using the deviation in the optimization problem for the enhanced imaging dataset after optimization. The defect detection can also be carried out by a computer.

According to an embodiment, the reference dataset is different from the imaging dataset and the one or more learned filters are derived to minimize the deviation of the imaging dataset from the reference dataset such that defects can be detected by comparing the enhanced imaging dataset and the reference dataset. According to another embodiment, the reference dataset can be identical to the imaging dataset. In this case, assumptions can be imposed on the one or more learned filters and defects can be detected by comparing the enhanced imaging dataset to the imaging dataset. Assumptions can lead to constraints imposed on the filters in the optimization problem, e.g., linearity of a filter. Hard constraints must be fulfilled and are implemented using side constraints in the optimization problem, soft constraints are usually added to the objective using a weighting factor that determines to what degree the soft constraint is fulfilled by the solution to the optimization problem.

According to an example, at least one of the one or more learned filters is a linear filter. For example, for small deviations between the imaging dataset and the reference dataset linearity of the one or more learned filters can be assumed.

According to an example, at least one of the one or more learned filters is a translation invariant filter. A translation invariant filter (or shift-invariant filter) is a filter that yields the same result for shifted versions of the imaging dataset. Thus, the application of the translation invariant filter to an imaging dataset is simple and does not introduce any location bias. A linear, translation invariant filter can be applied to an imaging dataset by convolving the imaging dataset with the filter. The convolution can be carried out in the frequency space, which is very fast and easy to implement.

According to an example, at least one of the one or more learned filters is a finite impulse response filter (FIR), which only uses a limited number of discrete samples for computing the filtering result. An FIR filter can be used to describe local effects in the imaging dataset. If the imaging dataset is larger than the FIR filter, the optimization problem is well posed leading to more accurate image enhancement and defect detection results.

According to an example, at least one of the one or more learned filters is a linear, translation invariant and finite impulse response (LTI) filter. LTI filters can be studied in the frequency domain, are easy to optimize and fast to apply. They combine the advantages of linear, translation invariant and finite impulse response filters described above.

According to an example, at least one learned filter is applied by use of convolution. In particular, the enhanced imaging dataset is generated by convolving the acquired imaging dataset with the one or more learned filters. Alternatively, the filtered reference dataset is generated by convolving the reference dataset with the one or more learned filters. Since a convolution can be carried out in frequency space, the application of the one or more learned filters can be performed very quickly, thus improving the throughput of the defect detection method.

According to an example, a single learned filter is applied. In particular, the imaging dataset or the reference dataset is filtered using a single learned filter, e.g., a single LTI filter. In this way, formulating and solving the optimization problem for obtaining the learned filter is simple and efficient, and the application of the single learned filter is very fast. According to another example, the imaging dataset or reference dataset is filtered using two or multiple learned filters, e.g., a cascade of learned filters that are subsequently applied to the imaging dataset or reference dataset such that a subsequent learned filter is applied to the filtering result of the previous learned filter. The cascade of learned filters can comprise linear and non-linear learned filters. In this way, more complex filtering operations can be implemented by using two or multiple less complex filtering operations, e.g., a sharpening filter and a contrast enhancement filter.

The one or more learned filters can be used in two ways: the learned filters are used to map the imaging dataset to an enhanced imaging dataset that is similar to the reference dataset. Alternatively, one or more assumptions are imposed on one or more of the learned filters in the optimization problem, and the reference dataset is identical to the imaging dataset. An assumption leads to a hard or a soft constraint. A hard constraint must be fulfilled by the solution of the optimization problem, a soft constraint only influences the solution of the optimization problem. Assumptions that can be imposed on a learned filter are, for example, linearity, translation invariance, finite impulse responsivity or restrictions on the size of the enhanced imaging dataset. Then defects can be detected by comparing the enhanced imaging dataset obtained by applying the one or more learned filters to the (original) imaging dataset. The comparison can, for example, be carried out by computing a difference image and comparing the differences to a threshold. Differences above a threshold indicate a defect.

According to an embodiment of the invention, the one or more learned filters are obtained by training a machine learning model. Machine learning models comprise objective functions in the form of loss functions, which are optimized in a training scheme using training data. By using a machine learning model, the one or more learned filters can be obtained automatically in a data-driven way and are optimal with respect to the training data without having to be manually defined. In this way, also cascades of two or multiple learned filters can be automatically learned from training data, e.g., by training a machine learning model comprising different linear and/or non-linear filters. The machine learning model can be trained to map the imaging dataset (or patches thereof) to the reference dataset. A patch refers to a subset of the imaging dataset, e.g., a rectangular region. The imaging dataset can be subdivided into overlapping patches. Alternatively, the machine learning model can be trained to reconstruct the imaging dataset by imposing assumptions on the one or more learned filters in the machine learning model. Machine learning models such as subspace methods (e.g., principal component analysis or independent component analysis), autoencoders or inpainting models or convolutional neural networks (CNNs) can be used.

In an example, the machine learning model operates on patches, in particular patches of the acquired imaging dataset or patches of the reference dataset. In this way, one or more localized filters can be learned. Since the one or more learned filters are locally limited, the optimization problem for training the machine learning model is well-defined and can be solved using less training data, in particular training data comprising only patches of the imaging dataset and/or patches of the reference dataset as training data. Additional patch training data can be used as well.

According to an example, the machine learning model learns a lower dimensional subspace of the patches, wherein the reference dataset is identical to the imaging dataset, and wherein the one or more learned filters represent the projection operation into the subspace and back to the patch space. The machine learning model can, for example, comprise a principal component analysis or an independent component analysis. The projection operation for projecting the patches into the subspace and back to the image space can be written as one or more learned filters. The filters are learned filters, since they are obtained from patches, in particular patches of the imaging dataset or the reference dataset. Additionally, patches from other acquired or simulated imaging datasets or reference datasets can be used for learning the subspace. Depending on the formulation of the optimization problem for deriving the subspace from the patch training data, versatile learned filters can be flexibly defined to satisfy different objective functions. In addition, subspace methods are usually fast and simple to apply. Thus, the application of the one or more learned filters can be performed quickly. For example, principal component analysis can be used to preserve as much information as possible of the patches in the subspace. Independent component analysis can be used to preserve the most important semantic parts of the patches in the subspace. Other subspace methods with other objective functions can be used as well.

According to an example, the machine learning model comprises a neural network and uses the weights and/or activation functions of one or more layers of the neural network as one or more learned filters. The neural network comprises a set of layers, and each intermediate layer consists of a number of neurons. Each neuron is connected to the output of several or all neurons of the previous layer using weights. The weights are learned from training data. The weights connected to a single neuron then form a learned filter. The activation function in each neuron describes how the weighted linear combination of inputs is transferred to an output of the neuron. It can introduce non-linearity. The parameters of the activation function can also be learned from training data. The activation functions can be used in combination with the learned weights to form a non-linear filter. The weights can be transformed to weight matrices, which can then be convolved with the image. The activation function can, optionally, be applied to the filter result. In particular, the neural network can be a convolutional neural network. The weights and/or activation functions of one or more of the layers can be used as a single or a cascade of linear and/or non-linear filters. The weights and/or activation functions are learned from the training data.

According to an example, the optimization problem comprises the deviation of further enhanced imaging datasets from corresponding reference datasets, wherein the further enhanced imaging datasets are generated by applying the one or more learned filters to further imaging datasets. The further imaging datasets and corresponding reference datasets can be acquired or simulated in addition to the imaging dataset. They can show the same region of the same object or a different region of the same object or a region of a different object. The reference datasets corresponding to the further imaging datasets can be obtained in the same way as the reference dataset of the imaging dataset. In this way, further imaging datasets and corresponding reference datasets can be used to derive the one or more learned filters. In this way, learned filters that are applicable to a broader set of imaging datasets can be obtained.

According to an example, the optimization problem comprises the deviation of further filtered reference datasets from further imaging datasets, wherein the further filtered reference datasets are generated by applying the one or more learned filters to further reference datasets. In this way, further reference datasets and further imaging datasets can be used to derive the one or more learned filters. In this way, learned filters that are applicable to a broader set of imaging datasets and reference datasets can be obtained.

The deviation of an enhanced imaging dataset from the corresponding reference dataset can be measured by an L₂ or L₁ metric, by a mean squared error loss function, by a mean absolute error loss function or by a Huber loss function or by any other metric. The Huber loss function is a combination of an L₂ metric for small deviations and an L₁ metric for larger deviations. In this way, the loss function is differentiable and at the same time does not over-penalize larger deviations, i.e., outliers such as defects. Thus, the accuracy of the defect detection is improved. The optimization problem can be solved using, for example, robust regression or any mathematical solver, e.g., for solving systems of equations such as the conjugate gradients method or derivations thereof.

A method for image enhancement according to another embodiment of the invention comprises: acquiring an imaging dataset of an object comprising integrated circuit patterns using an imaging system; obtaining a reference dataset corresponding to the imaging dataset; one or more iterations comprising: a) obtaining a subset of the imaging dataset and a corresponding subset of the corresponding reference dataset, and b) applying a method for image enhancement described above to the subset of the imaging dataset and the corresponding subset of the corresponding reference dataset. In at least one iteration one or more learned filters obtained in any of the previous steps are used as initial value for the one or more learned filters to be optimized in the optimization problem. Finally, the enhanced subsets of the imaging dataset are combined to obtain an enhanced imaging dataset.

A method for defect detection according to another embodiment of the invention comprises: acquiring an imaging dataset of an object comprising integrated circuit patterns using an imaging system; obtaining a reference dataset corresponding to the imaging dataset; one or more iterations comprising: a) obtaining a subset of the imaging dataset and a corresponding subset of the corresponding reference dataset, and b) applying any method for defect detection described above to the subset of the imaging dataset and the corresponding subset of the corresponding reference dataset to detect defects. In at least one iteration one or more learned filters obtained in any of the previous steps are used as initial value for the one or more learned filters to be optimized in the optimization problem. Finally, the detected defects are combined to obtain a defect detection in the imaging dataset. The system can generate a report containing information about the defect detection

All processing steps for processing imaging datasets and/or the reference datasets can be carried out by a computer.

A data processing apparatus according to an embodiment of the invention is configured for carrying out a method for image enhancement or defect detection according to any of the embodiments or examples of the invention above.

A computer program according to an embodiment of the invention comprises instructions which, when the program is executed by a computer, cause the computer to carry out a method for image enhancement or defect detection according to any of the embodiments or examples described above.

A computer-readable medium according to an embodiment of the invention has a computer program executable by a computing device stored thereon, the computer program comprising code for executing a method for image enhancement or defect detection according to any of the embodiments or examples described above.

A system for image enhancement according to an embodiment of the invention comprises: an imaging system configured to provide an imaging dataset of an object comprising integrated circuit patterns; one or more processing devices; one or more machine-readable hardware storage devices comprising instructions that are executable by one or more processing devices for executing a method for image enhancement according to any of the embodiments or examples described above.

A system for defect detection according to an embodiment of the invention comprises an imaging system configured to provide an imaging dataset of an object comprising integrated circuit patterns; one or more processing devices; and one or more machine-readable hardware storage devices comprising instructions that are executable by one or more processing devices for executing a method for defect detection according to any of the embodiments or examples described above.

The invention described by examples and embodiments is not limited to the embodiments and examples but can be implemented by those skilled in the art by various combinations or modifications thereof.

### BRIEF DESCRIPTION OF DRAWINGS

FIG. 1 illustrates an exemplary transmission-based photolithography system, e.g., a deep ultraviolet (DUV) photolithography system;

FIG. 2 illustrates an exemplary reflection-based photolithography system, e.g., an extreme ultraviolet (EUV) photolithography system;

FIG. 3 shows an imaging dataset of an object comprising integrated circuit patterns in the form of a photolithography mask comprising a defect;

FIG. 4 illustrates a flowchart of a method for image enhancement or defect detection in an object comprising integrated circuit patterns according to an embodiment of the invention;

FIG. 5 shows a design of a photolithography mask including a defect of size 20 nm, an imaging dataset and a reference dataset;

FIG. 6 shows a difference image indicating the difference between the imaging dataset and the reference dataset in FIG. 5;

FIG. 7 shows the difference image of FIG. 6 after shift correction;

FIG. 8 illustrates the application of a learned filter to the imaging dataset to enhance the image and detect defects;

FIG. 9 shows the Huber loss function for δ=1, which is optimized to obtain the learned filter in FIG. 8;

FIG. 10 shows results for an imaging dataset including imaging artifacts of 70 nm defocus and wavefront errors;

FIG. 11 shows results for an imaging dataset comprising non-periodic structures;

FIG. 12 shows results for an imaging dataset comprising TDI blur of 0.7 compared to a reference dataset comprising TDI blur of 1.3 pixels;

FIG. 13 shows results for an imaging dataset comprising random wavefront errors between 0.01 and 0.1 nm;

FIG. 14 shows results for an imaging dataset comprising imaging artifacts of 70 nm defocus, wavefront errors and shot noise;

FIG. 15 illustrates a flowchart of a method for image enhancement or defect detection in an object comprising integrated circuit patterns according to an embodiment of the invention; and

FIG. 16 illustrates a system for image enhancement or defect detection according to an embodiment of the invention.

### DETAILED DESCRIPTION

In the following, advantageous exemplary embodiments of the invention are described and schematically shown in the figures. Throughout the figures and the description, same reference numbers are used to describe same features or components.

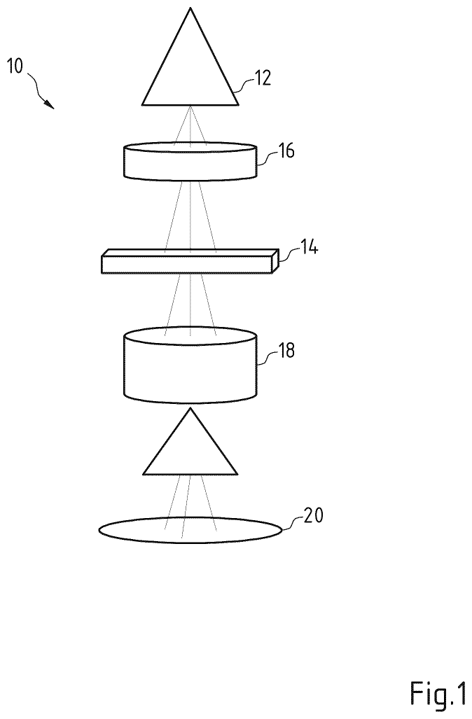

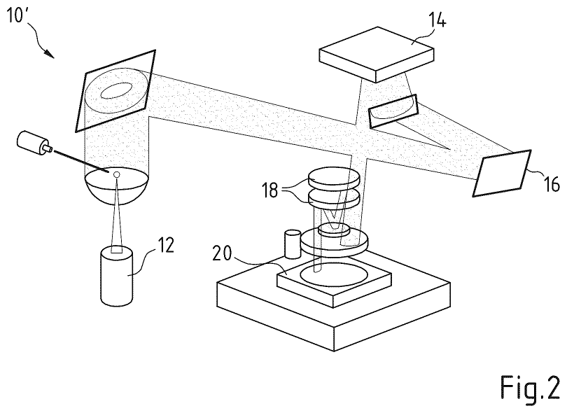

The methods described herein can be used, for example, with transmission-based photolithography systems 10 or reflection-based photolithography systems 10′ as shown in FIGS. 1 and 2.

FIG. 1 illustrates an exemplary transmission-based photolithography system 10, e.g., a DUV photolithography system. Major components are a light source 12, which may be a deep-ultraviolet (DUV) excimer laser source, imaging optics, and which may include optics that shape radiation from the light source 12, a photolithography mask 14, illumination optics 16 that illuminate the photolithography mask 14 and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

In the present document, the terms “radiation” or “beam” are used to encompass all types of electromagnetic radiation, including ultraviolet radiation (e.g., with wavelengths of 365, 248, 193, 157 or 126 nm) and EUV (extreme ultra-violet radiation, e.g. having a wavelength in the range of about 3-100 nm).

Illumination optics 16 may include optical components for shaping, adjusting and/or projecting radiation from the light source 12 before the radiation passes the photolithography mask 14. Projection optics 18 may include optical components for shaping, adjusting and/or projecting the radiation after the radiation passes the photolithography mask 14. The illumination optics 16 exclude the light source 12, the projection optics 18 exclude the photolithography mask 14.

Illumination optics 16 and projection optics 18 may comprise various types of optical systems, including refractive optics, reflective optics, apertures and catadioptric optics, for example. Illumination optics 16 and projection optics 18 may also include components operating according to any of these design types for directing, shaping or controlling the projection beam of radiation, collectively or singularly.

FIG. 2 illustrates an exemplary reflection-based photolithography system 10′, e.g., an extreme ultraviolet light (EUV) photolithography system 10′. Major components are a light source 12, which may be a laser plasma light source, illumination optics 16 which, for example, define the partial coherence and which may include optics that shape radiation from the light source 12, a photolithography mask 14, and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

The production of objects comprising integrated circuit patterns such as photolithography masks and wafers requires great care due to the small structure sizes of the integrated circuit patterns. Defects cannot be prevented but can lead to the malfunctioning of semiconductor devices. Therefore, accurate and fast methods for image enhancement and defect detection in objects comprising integrated circuit patterns such as photolithography masks, reticles or wafers is important.

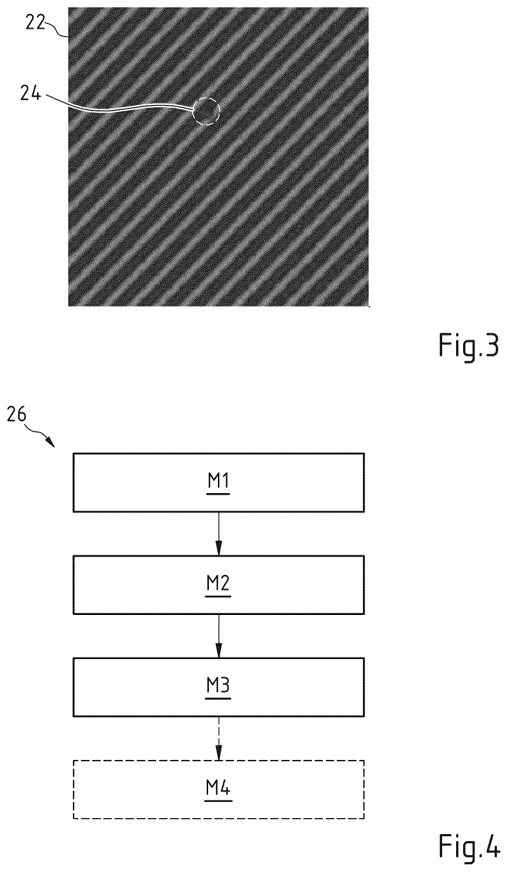

FIG. 3 shows an imaging dataset 22 of an object comprising integrated circuit patterns in the form of a photolithography mask 14 comprising a defect 24. Methods known from the art often use die-to-die or die-to-database methods to detect such defects 24. The imaging dataset 22, in this case, can include a single image of a portion of the object. An imaging dataset 22 can generally refer to one or more images of one or more portions of the object. Die-to-die methods compare a portion of the imaging dataset 22 to another portion of the same or a different imaging dataset 22 to detect defects 24. However, the applicability of die-to-die methods is limited, e.g., repeater defects cannot be discovered and suitable portions for comparison have to be found. In addition, they require the availability and time-consuming scanning of two corresponding portions of the object and exact knowledge about their relative position. Die-to-database methods allow for the detection of any defect 24 by providing a reference dataset that can be directly compared to an imaging dataset 22 of the object comprising integrated circuit patterns. However, the imaging dataset is subject to various effects causing systematic deviations from the reference image, including defocus, shifts, aberrations, time-delayed integration (TDI) blur, wave front errors and thermal drift, etc. These systematic deviations can lead to many false positive defect detections. In addition, images usually contain a lot of redundant information, which makes it difficult to extract the relevant information for defect detection. Therefore, it is a feature of the invention to provide image enhancement and defect detection methods for objects comprising integrated circuit patterns with an improved accuracy and specificity.

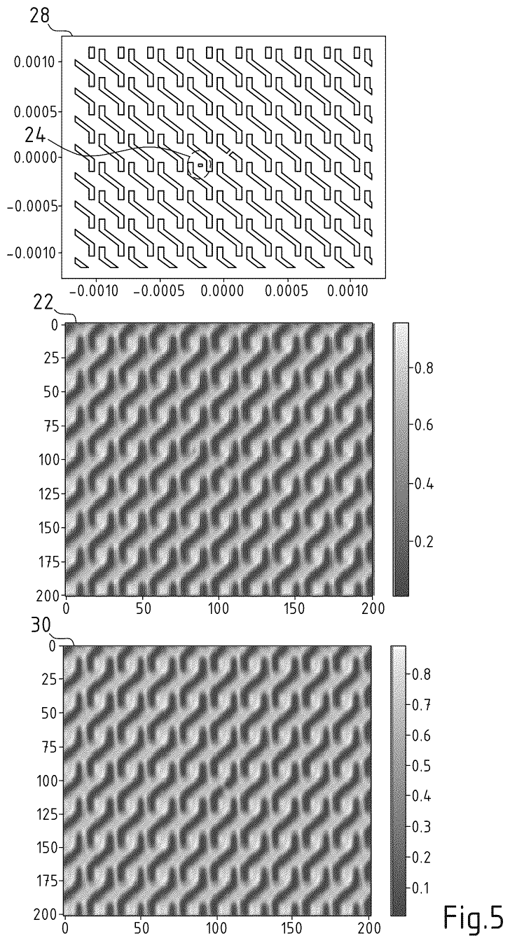

FIG. 4 illustrates a flowchart of a method 26 for image enhancement in an object comprising integrated circuit patterns according to an embodiment of the invention. The method comprises the following steps: in a step M1, an imaging dataset 22 of an object comprising integrated circuit patterns is acquired using an imaging system; in a step M2 a reference dataset corresponding to the acquired imaging dataset is obtained; in a step M3 an enhanced imaging dataset is generated by filtering the acquired imaging dataset 22 with one or more learned filters, wherein the one or more learned filters are obtained by solving an optimization problem. Optionally, in a step M4, defects are detected in the imaging dataset 22 by comparing the enhanced imaging dataset 38 to the corresponding reference dataset 30. This procedure is illustrated in FIGS. 5, 6 and 7.

FIG. 5 shows a defective design 28 of a photolithography mask including a defect 24 of size 20 nm, an imaging dataset 22 and a reference dataset 30. The imaging dataset 22 is obtained using an imaging system, e.g., a scanning electron microscope (SEM), a focused ion beam (FIB) microscope, an atomic force microscope (AFM), an aerial image measurement system, e.g., equipped with a staring array sensor or a line-scanning sensor or a time-delayed integration (TDI) sensor, Xray, etc. Due to non-ideal optics in the imaging system, the imaging dataset 22 is subject to systematic deviations during the acquisition process resulting in imaging artifacts. The systematic deviations include shifts, defocus, aberrations, TDI blur, wave front errors, thermal drift, etc., yielding imaging artifacts such as translations, blur, noise, color variations, intensity variations, sharpness variations or contrast variations, etc. The imaging dataset 22 in FIG. 5 was acquired using an EUV photolithography system with 70 nm defocus. The reference dataset 30 corresponds to an imaging dataset 22 acquired using the same EUV photolithography system without defocus. At 70 nm defocus imaging artifacts occur. The contrast of the imaging dataset 22 is slightly higher than that of the reference dataset 30 without defocus. In addition, the imaging dataset 22 is slightly shifted with respect to the reference dataset 30.

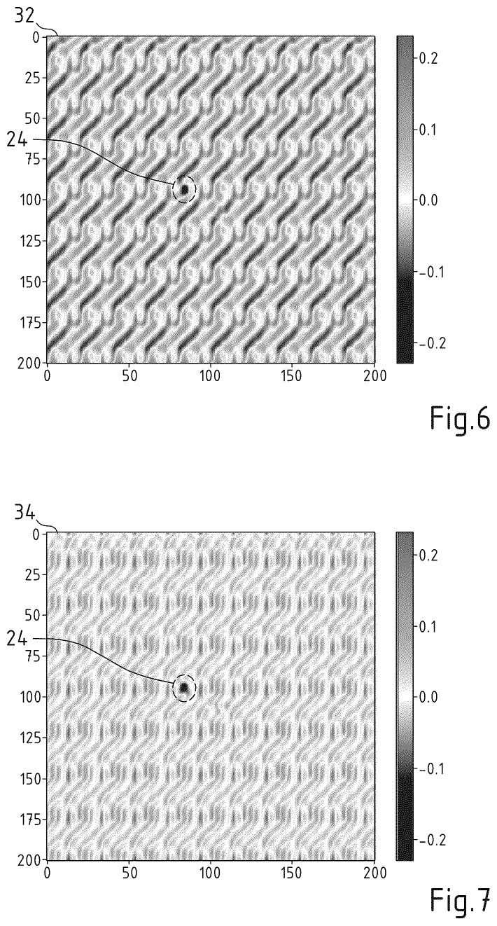

FIG. 6 shows a difference image 32 indicating the difference between the imaging dataset 22 and the reference dataset 30 in FIG. 5. The contrast variation and the translations make the detection of the defect 24 difficult. FIG. 7 shows a shift corrected difference image 34. To obtain the shift corrected difference image 34, a shift corrected imaging dataset is computed by applying a shift operator to the imaging dataset 22. The shift operator includes a horizontal and vertical shift and is obtained by solving an optimization problem minimizing the deviation of the shift corrected imaging dataset from the imaging dataset 22. The shift corrected difference image 34 is then obtained as the deviation of the imaging dataset 22 from the shift corrected imaging dataset. Even if the shifts are corrected as shown in FIG. 7 numerous imaging artifacts remain and make the detection of the defects 24 difficult.

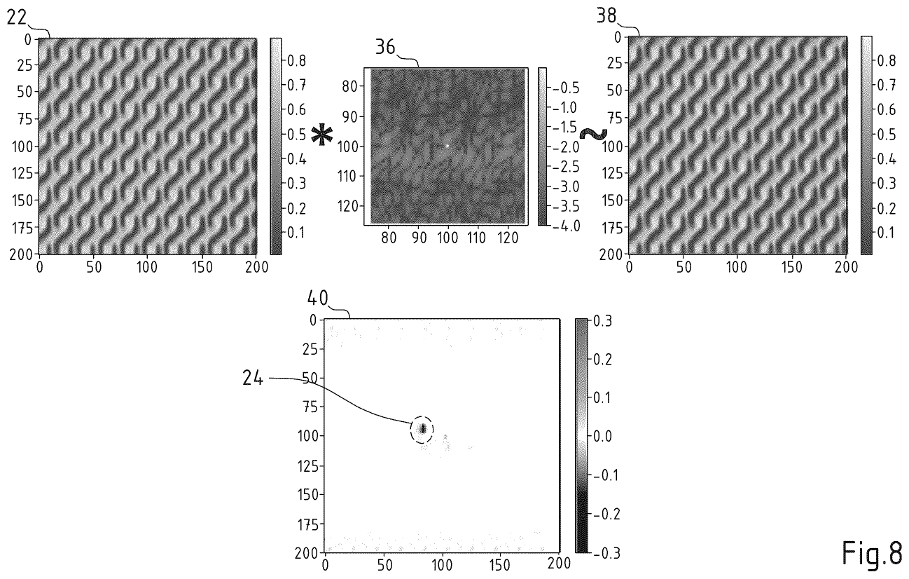

In order to reduce the imaging artifacts and improve defect detection as illustrated in FIG. 8, the method according to the invention generates an enhanced imaging dataset 38 by filtering the acquired imaging dataset 22 with one or more learned filters 36 using, e.g., convolutions, wherein the one or more learned filters 36 are obtained by solving an optimization problem. The optimization problem can be formulated in such a way that the imaging artifacts due to systematic deviations during the image acquisition process are reduced, while the defects 24 are preserved. Thus, by computing a difference image 40 of the enhanced imaging dataset 38 and the reference dataset 30, defects 24 can be reliably and accurately detected and false positive defect detections are reduced.

In an example, the enhanced imaging dataset 38 is generated by filtering the imaging dataset 22 with a single learned filter 36. Alternatively, the enhanced imaging dataset 38 can be generated by filtering the imaging dataset 22 with two or multiple learned filters 36. In case of two or multiple learned filters 36, the learned filters 36 can form a cascade of learned filters 36, such that a subsequent learned filter 36 is applied to the result of the filtering operation with the previous learned filter 36. In this way, each learned filter 36 can be formulated with regard to different aspects of the imaging dataset 22, e.g., with regard to a different imaging artifact. For example, a low-pass filter reduces noise, a high-pass filter preserves edges, a sharpening filter reduces blur, etc. The one or more learned filters can be linear and/or non-linear.

In an example, the one or more learned filters 36 are subject to additional assumptions, i.e. the filter has specific properties. For example, at least one of the one or more learned filters 36 can be a linear filter and/or a translation invariant filter and/or a finite impulse response filter, an image size reducing filter, a compression filter etc. In an example according to the invention, the learned filter 36 is a linear, translation invariant and finite impulse response filter as shown in FIG. 8. The enhanced imaging dataset 38 can be generated by convolving the imaging dataset 22 with the one or more learned filters 36.

The size of the filter depends on the size of the pixels and can be determined using experiments. In FIG. 8, a filter size of 51×51 was used. Other filter sizes such as 100×100, etc., can be used as well.

By comparing the enhanced imaging dataset 38 to the reference dataset 30, e.g., by computing the difference image 40 between the enhanced imaging dataset 38 and the reference dataset 30, defects 24 can be detected reliably and accurately as shown in FIG. 8.

The one or more learned filters 36 are obtained by solving an optimization problem. The optimization problem can be formulated in different ways. The optimization problem comprises the deviation of the enhanced imaging dataset 38 from the reference dataset 30. By directly minimizing this deviation, the one or more learned filters 36 are specifically adapted to the imaging dataset 22 and the reference dataset 30 at hand. Thus, no additional data, e.g., training data, or further knowledge about the systematic deviations or imaging artifacts in the imaging dataset 22 is required. In addition, imaging artifacts can be removed successfully, since the optimization problem directly minimizes the deviation of the imaging dataset 22 and the reference dataset 30 at hand. The optimization problem, thus, directly operates on the acquired imaging dataset 22 and the corresponding reference dataset 30.

A learned filter F can, for example, be obtained by minimizing the following objective function:

$$F = {arg min}_{F} L ( I , R , F ) ,$$

where F indicates the one or more learned filters 36, L indicates a loss function, I indicates the imaging dataset 22 and R indicates the reference dataset 30. Various formulations of the loss function are conceivable.

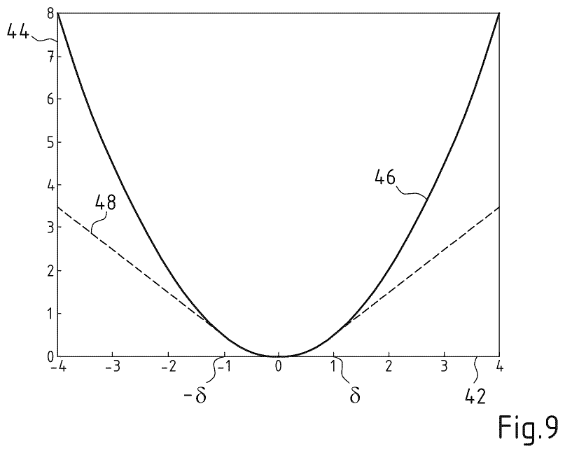

For example, in case of an LTI filter, one of the following objective functions can be optimized:

$$\begin{matrix}F = {arg min}_{F} mean f ( I * F - R ) , \\ F = {arg min}_{F} mean f ( I - R * F ) ,\end{matrix} \qquad ( 1 )$$

where * indicates a convolution, mean a mean value, and f some kind of function, e.g., a pixel-wise norm such as an Lₚ norm for p>0, e.g., an L₁ or L₂ norm. Alternatively, a mean squared error loss function or a mean absolute error loss function can be used. Alternatively, a Huber loss function as illustrated in FIG. 9 or any of its variants can be used. The Huber loss function for some parameter δ≥0 can be defined as follows:

$${L}_{δ} ( a ) = \{ \begin{matrix}\frac{1}{2} {a}^{2} , & if \vert a \vert \leq δ \\ δ ( \vert a \vert - \frac{1}{2} δ ) , & otherwise .\end{matrix}$$

FIG. 9 shows the Huber loss function for δ=1. On the horizontal axis 42 the deviation is shown, on the vertical axis 44 the loss is shown. Small deviations a within the range [−δ; δ] are penalized using the mean squared error 46, whereas larger deviations are penalized using the mean absolute error 48. Thus, the loss function is differentiable and does not over-penalize outliers. δ can, for example, be selected based on the image value range, based on the noise level and/or based on the variance a of the intensity distribution in the difference image 32 of the imaging dataset 22 and the reference dataset 30, e.g., δ=3 σ. δ can, for example, be selected from the range [0; 2], preferably from the range [0; 1], more preferably from the range [0; 0.3]. A preferred value is 6=0.05 to remove noise but not the defects 24. The resulting learned filter 36 is a linear, translation invariant, finite impulse response (LTI) filter shown in FIG. 8. The optimization problem in (1) can, for example, be solved using iterative methods such as conjugate gradients or limited-memory Broyden-Fletcher-Goldfarb-Shanno (LBFGS). Any other method, for example a robust regression, can be used as well.

In some implementations, the function to be optimized can be written as

$${arg min}_{F}$$

mean f(I*F−R). The filter F is a two-dimensional array that is convolved with the image. The values of the filter F can vary. They are optimized by solving an optimization problem. The derivative of this function is set to 0. It is linear and can be written as a linear system of equations with a positive definite matrix. This system of equations can be solved using, for example, the conjugate gradients method, LBFGS or robust regression. In case there are two or more filters to be optimized, they can be combined to a single filter with variable entries due to the linearity of the convolution. Again, the derivative is set to 0 and can be written as a linear system of equations with a positive definite matrix that can be solved, for example, using conjugate gradients, LBFGS or robust regression.

According to another embodiment, the optimization problem is formulated as a machine learning problem.

Machine learning is a field of artificial intelligence. Machine learning methods are data-driven methods that learn underlying concepts automatically from training data such that the problem is solved optimally and automatically without humans having to define rules or additional high-level knowledge. Machine learning methods generally build a parametric machine learning model based on training data. After training, the method is able to generalize the knowledge gained from the training data to new previously unencountered samples, thereby making predictions for new data. There are many machine learning methods, e.g., linear regression, k-means, support vector machines, neural networks or deep learning approaches comprising transformer architectures.

Deep learning is a class of machine learning that uses artificial neural networks with numerous hidden layers between the input layer and the output layer. Due to this complex internal structure the networks are able to progressively extract higher-level features from the raw input data. Each level learns to transform its input data into a slightly more abstract and composite representation by using different filters, thus deriving low and high level knowledge from the training data. The hidden layers can have differing sizes and tasks such as convolutional or pooling layers.

In an embodiment of the invention, the reference dataset 30 is identical to the imaging dataset 22. In this case, the enhanced imaging dataset 38 is compared to the imaging dataset 22 to detect defects 24. The one or more learned filters 36 can be obtained by imposing additional assumptions on the one or more learned filters 36 in the optimization problem, e.g., that the size of the imaging dataset 22 is reduced (e.g. by using a sampling filter that reduces the number of pixels, e.g., a binning filter), that the one or more learned filters 36 are linear, that the enhanced imaging dataset 38 lies within a lower-dimensional subspace of the imaging dataset 22, etc.

In an example, the one or more learned filters 36 are obtained by training a machine learning model, which operates on patches of the acquired imaging dataset 22. Patches are subsections of the imaging dataset 22. The imaging dataset 22 is subdivided into overlapping patches such that each pixel of the imaging dataset is the center pixel of a patch, and the machine learning model is applied to each patch separately. To this end, the patches can be of a specific size and shape and can be used as training data patches. Preferably, the size of the patches is selected according to the expected size of the expected defects in the imaging dataset 22. Depending on the type of integrated circuit patterns on the photolithography mask and on the inspection system acquiring the imaging dataset, a typical size of typical defects can be estimated. The training data for training the machine learning model can include only patches from the imaging dataset 22 itself, or it can include additional patches from other imaging datasets 22, e.g., from imaging datasets acquired from a different location of the same object comprising integrated circuit patterns or from the same location of a different object comprising integrated circuit patterns, from design data or simulated data, etc. The machine learning model can use only patches of the imaging dataset 22 or, additionally, patches of the reference dataset 30. By using patches from the imaging dataset 22 itself as training data, the machine learning model is trained in an unsupervised way and learns to discriminate common structures from rare structures. The rarely occurring structures are then marked as potential defects. For example, an autoencoder can be trained in this way, which uses a patch as input and tries to reconstruct the patch.

In an example, the machine learning model uses meta information of the image acquisition process as additional input to the machine learning model, e.g., location information such as the location of the imaged portion of the object comprising integrated circuit patterns within the object, the type of object comprising integrated circuit patterns, information on the image acquisition process or the imaging system, etc.

According to an example, the machine learning model is trained to map patches of the imaging dataset 22 to corresponding patches of the reference dataset 30 without imaging artifacts. A corresponding patch can, for example, be found at the same location in the reference dataset, or pattern matching methods such as correlation can be used to find patches that are highly similar to the patch of the imaging dataset. Thus, the machine learning model uses patches of the imaging dataset 22 and corresponding patches of the reference dataset 30 as training data, e.g., pairs of imaging dataset and reference dataset patches. The machine learning model can, for example, comprise a CNN. The CNN can contain a sequence of linear filters that are learned from training data. The CNN can also contain non-linear filters, e.g., activation functions or other types of layers such as pooling layers. Additional training dataset patches can be selected from other acquired or simulated or designed imaging datasets 22 and corresponding reference datasets 30, preferably from imaging datasets 22 and corresponding reference datasets 30 comprising similar structures that are predominantly defect-free (i.e., less than 10%, preferably less than 5%, most preferably less than 1% of the patches comprise an imaging artifact). Predominantly defect-free reference datasets can, for example, be obtained by use of simulation methods, by acquiring imaging datasets of photolithography masks that contain no or very few defects, etc. The loss function of the machine learning model comprises the deviation of the reconstructed imaging dataset patches from the corresponding reference dataset patches. An imaging dataset 22 can then be filtered or reconstructed by applying the one or more learned filters to a patch centered on a pixel and using the center pixel of the filtered patch as filtered pixel in the enhanced imaging dataset 38. The enhanced imaging dataset 38 is, thus, obtained by moving a patch over the imaging dataset 22, applying the one or more learned filters to the patch and saving the filtering result in the enhanced imaging dataset 38 at the location of the center pixel of the patch in the imaging dataset. Defects 24 can be detected by comparing the enhanced imaging dataset 38 to the reference dataset 30, e.g., using a difference image and one or more thresholds.

In another example, the machine learning model is trained to reconstruct the patches of the imaging dataset 22. To this end, the machine learning model is trained on patches that are selected, e.g., randomly, from the imaging dataset 22 itself. The imaging dataset 22 is, thus, used as training dataset. The reference dataset 30 is identical to the imaging dataset 22. Alternatively, additional patches can be selected from other acquired or simulated or designed imaging datasets, preferably from imaging datasets comprising similar structures and are predominantly free of imaging artifacts. The machine learning model can, for example, comprise an autoencoder model or an inpainting model. An autoencoder is a neural network that is trained to reconstruct the input with as little deviation as possible. The neural network contains an encoder part that encodes the input using two or more intermediate layers that gradually reduce the spatial size of the input up to the so-called bottleneck. After the bottleneck, the neural network contains a decoder part containing usually the same number of layers as the encoder that gradually increase the spatial size of the input until the same size as the input is reached. Due to the encoding of the input in a feature vector of smaller size in the bottleneck, only the most important information can be preserved by the autoencoder. Rarely occurring information such as defects are, thus, removed from the input. By comparing the reconstructed input to the original input, defects can, thus, be detected. The loss function of the machine learning model can comprise the reconstruction error of the patches of the training dataset and the (original) patches of the training dataset. An imaging dataset 22 can then be filtered or reconstructed by applying the one or more learned filters derived from the trained machine learning model to a patch centered on a pixel and using the center pixel of the reconstructed patch as filtered pixel in the enhanced imaging dataset 38. The learned filters can, for example, be extracted from the weights or activation functions of a neural network. The learned filters can be convolved with the patches of the imaging dataset 22. Defects 24 can be detected by comparing the filtered (reconstructed) imaging dataset 38 to the imaging dataset 22, e.g., by computing a difference image and applying one or more thresholds to the difference image.

In an example, the machine learning model learns a lower dimensional subspace of the training data patches and a corresponding projection of a patch into the lower dimensional subspace and back to the image space. The projection can then be used as a learned filter 36. The projection can be written as a matrix multiplication, wherein the matrix contains coordinate axes of the subspace. Defects 24 can subsequently be detected by comparing the enhanced imaging dataset 38 to the imaging dataset 22. Thus, the reference dataset 30 is identical to the imaging dataset 22 in this case. For example, principal component analysis (PCA) or independent component analysis (ICA) can be used to extract the lower dimensional subspace of the training data. By using principal component analysis, a basis of the patch space can be extracted from the training data patches by computing eigenvectors of the covariance matrix of the centered training data. Each eigenvector is associated with an eigenvalue that indicates the amount of information preserved by the dimension of the corresponding eigenvector. By selecting a subspace spanned by N eigenvectors with the N highest eigenvalues most information of the original patches is preserved in the subspace. The remaining dimensions of the subspace correspond to eigenvectors with low eigenvalues and are removed. These dimensions usually contain rare occurrences in the training data patches such as imaging artifacts, e.g., noise or rarely occurring defects 24. Thus, by projecting a patch of the imaging dataset 22 into the learned subspace and reconstructing the patch from the projection, a filtered version of the patch is obtained which only contains the most important information contained in the learned subspace. Ideally, in this way defects 24 are removed from the patch, while the remaining information is preserved in the patch such that the difference image reveals the defects 24. Let A denote a matrix of row-eigenvectors obtained by computing the eigenvector decomposition of the covariance matrix of the 0 mean centered training patches, and let x indicate a vectorized patch of the imaging dataset 22. Then the reconstruction y of the patch x can be computed by

$$y = {( {( Ax )}^{T} A )}^{T} = {A}^{T} Ax .$$

Thus, the matrix A^{T} A can be seen as a linear filter that is applied to the imaging dataset 22 by use of convolution. The application of this linear filter to the imaging dataset 22 corresponds to a patch-wise projection of the imaging dataset 22 into the lower dimensional eigenspace and back to the image space, i.e., to a reconstruction of the imaging dataset 22 based on the information preserved in the eigenspace. In this way, imaging artifacts are reduced. Accordingly, instead of PCA, ICA or other subspace methods with different objectives can be used to obtain a learned filter.

In another example, the machine learning model comprises a neural network and uses the weights and/or activations of one or more layers of the neural network as one or more learned filters 36. The neural network comprises convolutional layers that each apply a learned filter 36 to the input of the respective layer to generate the desired result. The neural network can only consist of convolutional layers, or it can comprise activation functions or additional layers such as pooling layers, etc. The weights constitute linear filters, whereas activation functions or other types of layers constitute non-linear filters. The one or more filters are optimized during training and can be extracted from the neural network. The neural network can be trained to optimize some kind of loss function, e.g., an image enhancement loss function, a defect detection loss function, an image reconstruction loss function for reconstructing the reference dataset 30 from the imaging dataset 22, a defect segmentation loss function, etc. The neural network can use patches or the complete imaging dataset 22 as input. The size of the filters can be selected by defining the architecture of the neural network, i.e., the convolutional layers. The neural network can be trained on patches extracted from the imaging dataset 22 itself. The patches can be obtained by subdividing the imaging dataset into overlapping subsets of the same size, e.g., rectangular regions, such that each pixel is the center pixel of a patch. However, the number of these patches may be too low for training depending on the size of the neural network. Therefore, further patches of imaging datasets 22 can be used as training data, e.g., imaging datasets 22 of identical or similar portions of the same or of a different object comprising integrated circuit patterns can be used to generate sufficient amounts of training data.

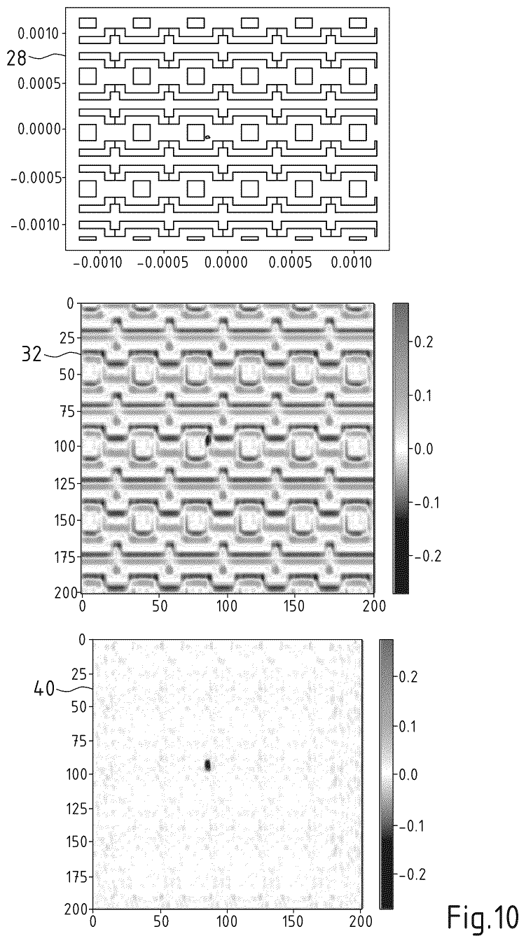

FIG. 10 shows results for an imaging dataset 22 including imaging artifacts of 70 nm defocus and wavefront errors. The upper graph shows a design 28 including a small defect, the middle graph shows a simple difference image 32 of imaging dataset 22 and reference dataset 30, and the lower graph shows a difference image 40 after filtering the imaging dataset 22 using the learned filter 36 in FIG. 8. Using a simple difference image 32, the defects cannot be detected (or may be difficult to detect) due to the imaging artifacts. The learned filter 36 in FIG. 8 is obtained by solving the optimization problem in (1) and is applied to the imaging dataset 22. The difference image 40 can be obtained by subtracting the reference dataset 30 from the enhanced imaging dataset 38. The difference image 40 contains only little imaging artifacts, whereas the defects are preserved and can be easily detected, e.g., by thresholding.

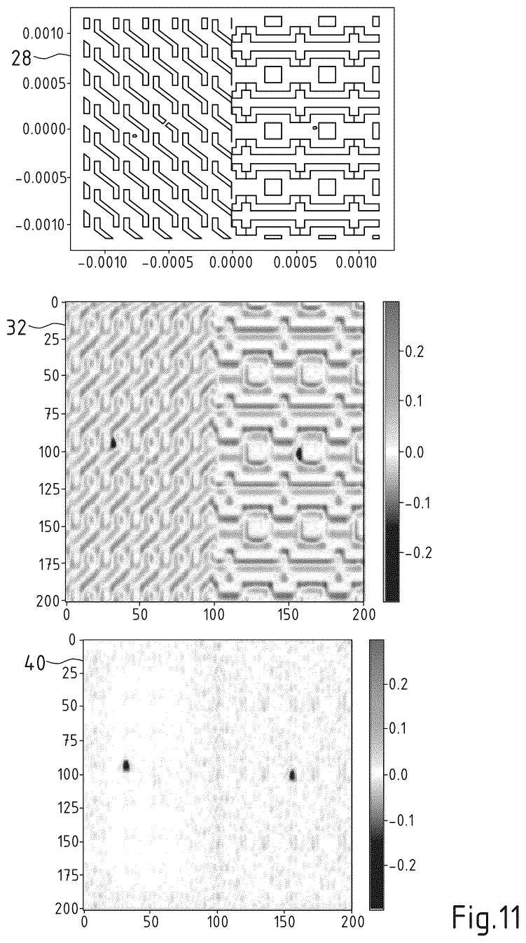

FIG. 11 shows results for an imaging dataset 22 comprising non-periodic structures. The upper graph shows a design 28 including a small defect, the middle graph shows a simple difference image 32 of imaging dataset 22 and reference dataset 30, and the lower graph shows a difference image 40 after filtering the imaging dataset 22 using the learned filter 36 in FIG. 8 Using a simple difference image 32, the defects cannot be detected (or may be difficult to detect) due to the imaging artifacts. Even after shift correction, the difference image still contains considerable amounts of imaging artifacts. By applying the learned filter 36 in FIG. 8 obtained by optimizing the optimization problem in (1), the difference image 40 can be obtained by subtracting the reference dataset 30 from the enhanced imaging dataset 38. The difference image 40 contains only little imaging artifacts despite the non-periodic structures, whereas the defects are preserved and can be easily detected, e.g., by thresholding.

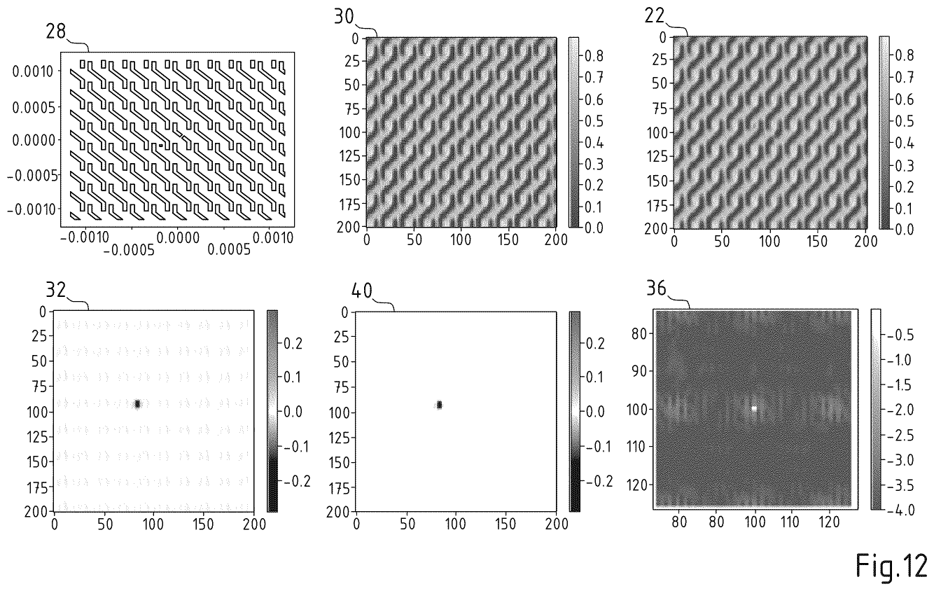

FIG. 12 shows results for an imaging dataset 22 comprising TDI blur of 0.7 and a reference dataset 30 comprising TDI blur of 1.3 pixels. The first row shows a design 28 including a small defect, a reference dataset 30 and an imaging dataset 22. The second row shows a simple difference image between reference dataset 30 and imaging dataset 22, a difference image 40 between enhanced imaging dataset 38 and reference dataset 30, and the learned filter 36. Using a simple difference image 32, the defects cannot be detected (or may be difficult to detect) due to the imaging artifacts. By applying the learned filter 36 obtained by solving the optimization problem in (1), the difference image 40 can be obtained by subtracting the reference dataset 30 from the enhanced imaging dataset 38. The difference image 40 contains only little imaging artifacts, whereas the defects 24 are preserved and can be easily detected, e.g., by thresholding. Periodicity does not matter in this case, since the TDI effect exactly corresponds to an LTI filter. Instead of a 2D filter, a 1D filter could also be used. The method can be applied independent of the exact TDI blur (sinc or other form).

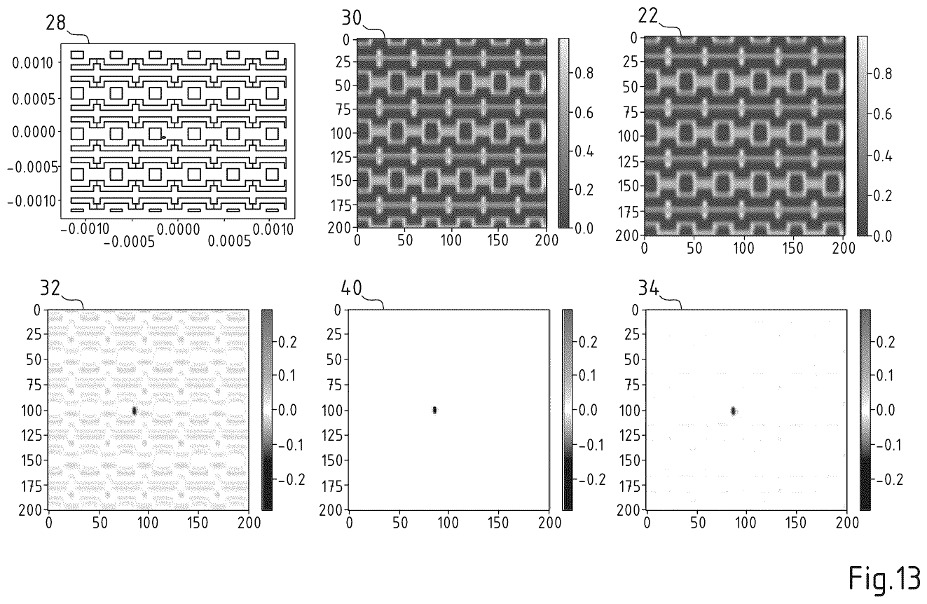

FIG. 13 shows results for an imaging dataset 22 comprising random wavefront errors between 0.01 and 0.1 nm. The first row shows a design 28 including a small defect, a reference dataset 30 and an imaging dataset 22. The second row shows a simple difference image between reference dataset 30 and imaging dataset 22, a difference image 40 between enhanced imaging dataset 38 and reference dataset 30, and the learned filter 36. The random wavefront errors correspond to randomly drawn Zemike polynomial coefficients for the imaging dataset 22 and the reference dataset 30. Using a simple difference image 32, the defects 24 cannot be detected (or may be difficult to detect) due to the imaging artifacts. Even when using a shift corrected difference image 34, the imaging artifacts are not sufficiently reduced to detect defects 24. By applying the learned filter 36 obtained by optimizing the optimization problem in (1), the difference image 40 can be obtained by subtracting the reference dataset 30 from the enhanced imaging dataset 38. The difference image 40 contains only little imaging artifacts, whereas the defects 24 are preserved and can be easily detected, e.g., by thresholding.

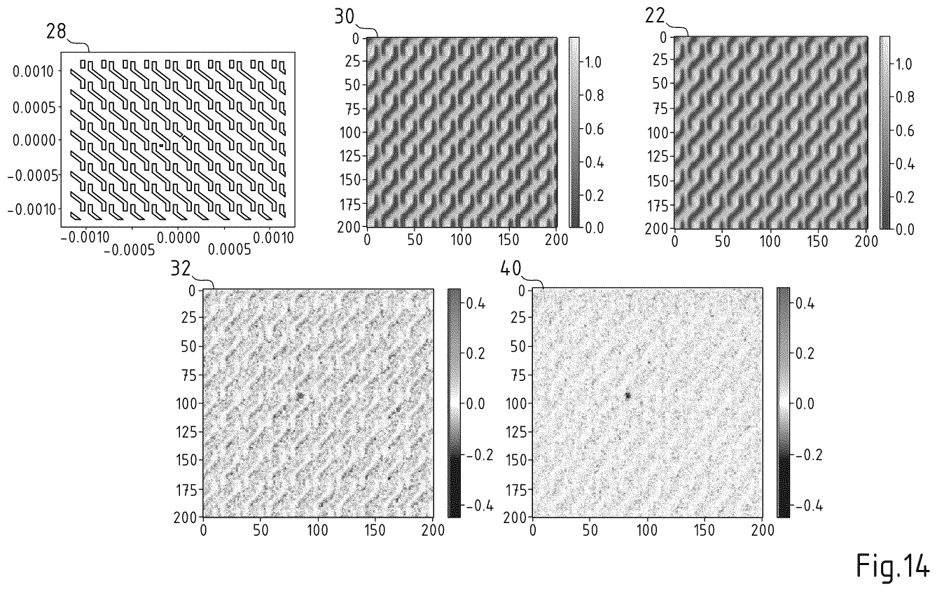

FIG. 14 shows results for an imaging dataset 22 comprising imaging artifacts of 70 nm defocus, wavefront errors and shot noise. Shot noise occurs in optical devices in case the photon number is low, thus causing random fluctuations of photons hitting pixels. The first row shows a design 28 including a small defect, a reference dataset 30 and an imaging dataset 22. The second row shows a simple difference image between reference dataset 30 and imaging dataset 22 and a difference image 40 between enhanced imaging dataset 38 and reference dataset 30. Using a simple difference image 32, the defects 24 cannot be detected (or may be difficult to detect) due to the imaging artifacts. By applying the learned filter 36 obtained by optimizing the optimization problem in (1), the difference image 40 can be obtained by subtracting the reference dataset 30 from the enhanced imaging dataset 38. The difference image 40 contains only little imaging artifacts, whereas the defects 24 are preserved and can be easily detected, e.g., by thresholding.

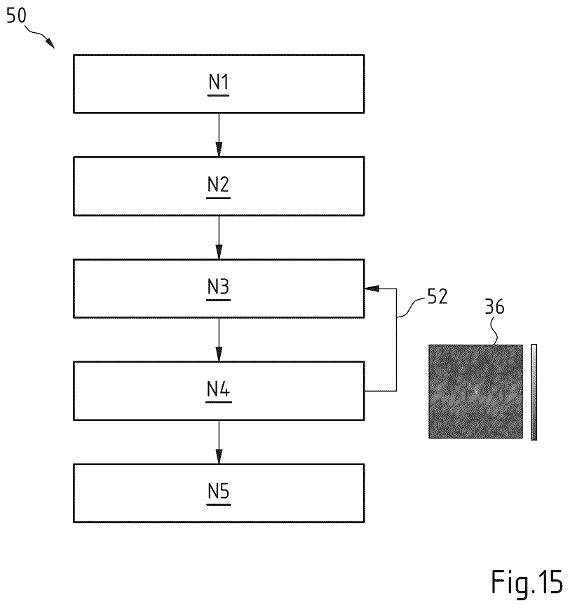

Imaging datasets 22 of wafers contain large amounts of data, which are usually subdivided into smaller portions that are analyzed for defects 24. Since many portions of the imaging dataset 22 are similar, e.g., in case of repetitive structures as, for example, in memory structures, the one or more learned filters 36 can be highly similar for different portions of the imaging dataset 22. Thus, it can be advantageous to re-use the one or more learned filters for different portions of the imaging dataset with similar structures. It is also advantageous to use the one or more learned filters 36 of another similar portion of the dataset 24 as initial values in the optimization problem. Therefore, a method 50 for image enhancement of defect detection according to an embodiment of the invention as illustrated in FIG. 15 comprises: acquiring an imaging dataset 22 of an object comprising integrated circuit patterns using an imaging system in a step N1; obtaining a reference dataset 30 corresponding to the imaging dataset 22 in a step N2; one or more iterations 52 comprising the following steps: obtaining a subset of the imaging dataset 22 and a corresponding subset of the corresponding reference dataset 30 in a step N3, and applying any of the methods 26 for image enhancement or defect detection described above to the subset of the imaging dataset 22 and the corresponding subset of the corresponding reference dataset 30 in a step N4, wherein in at least one iteration one or more learned filters 36 obtained in any of the previous steps are used as initial value for the one or more learned filters 36 to be optimized in the optimization problem. In a final step N5, the enhanced subsets of the imaging datasets or, respectively, the detected defects 24 are combined. For example, the enhanced subsets are re-combined to form a complete enhanced image. The detected defects 24 can, for example, also be combined to form a defect image, or their coordinates can be combined in a list of defect coordinates, etc.

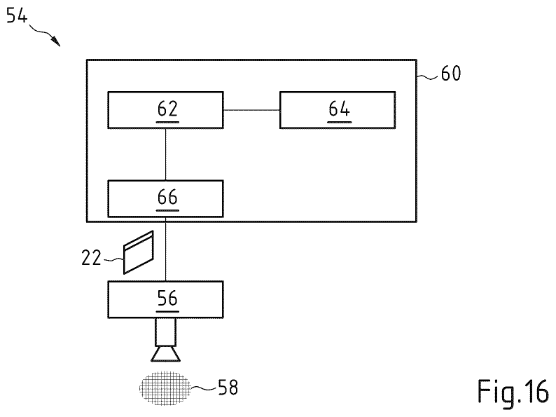

A system 54 for defect detection according to an embodiment of the invention illustrated in FIG. 16 comprises an imaging system 56 configured to provide an imaging dataset 22 of an object 58 comprising integrated circuit patterns and a data analysis device 60 comprising one or more processing devices 62 and one or more machine-readable hardware storage devices 64 comprising instructions that are executable by one or more processing devices 62 for executing any one of the methods for defect detection described above.

The imaging system 56 for obtaining an imaging dataset 22 of the object 58 comprising integrated circuit patterns can comprise a charged particle beam device, for example, a Helium ion microscope, a cross-beam device including FIB and SEM, an atomic force microscope or any charged particle imaging system, or an aerial image acquisition system. For example, the charged particle imaging system or aerial image acquisition system can include a charge-coupled device (CCD) or a complementary metal-oxide-semiconductor (CMOS) camera having at least one CCD or CMOS sensor having an array of individually addressable sensing elements or pixels. The imaging system 56 for obtaining an imaging dataset 22 of the object 58 comprising integrated circuit patterns can provide an imaging dataset 22 to the data analysis device 60. The data analysis device 60 includes one or more processing devices 62, e.g., implemented as a central processing unit (CPU) or graphics processing unit (GPU). The one or more processing devices 62 can receive the imaging dataset 22 via an interface 66. The one or more processing devices 62 can load program code from a hardware-storage device 64, e.g., program code for executing a method 26 for detecting defects 24 according to an embodiment of the invention as described above. The one or more processing devices 62 can execute the program code.

The methods disclosed herein can, for example, be used during research and development of objects comprising integrated circuit patterns or during high volume manufacturing of objects comprising integrated circuit patterns, or for process window qualification or enhancement. In addition, the methods disclosed herein can also be used for defect detection of X-ray imaging datasets of objects comprising integrated circuit patterns, e.g., after packaging the semiconductor device for delivery.

In some implementations, after the defects are found using the methods and systems described above, the photolithography mask can be modified to repair or eliminate the defects. Repairing the defects can include, e.g., depositing materials on the mask using a deposition process, or removing materials from the mask using an etching process. Some defects can be repaired based on exposure with focused electron beams and adsorption of precursor molecules.

In some implementations, a repair device for repairing the defects on a mask can be configured to perform an electron beam-induced etching and/or deposition on the mask. The repair device can include, e.g. an electron source, which emits an electron beam that can be used to perform electron beam-induced etching or deposition on the mask. The repair device can include mechanisms for deflecting, focusing and/or adapting the electron beam. The repair device can be configured such that the electron beam is able to be incident on a defined point of incidence on the mask.

The repair device can include one or more containers for providing one or more deposition gases, which can be guided to the mask via one or more appropriate gas lines. The repair device can also include one or more containers for providing one or more etching gases, which can be provided on the mask via one or more appropriate gas lines. Further, the repair device can include one or more containers for providing one or more additive gases that can be supplied to the one or more deposition gases and/or the one or more etching gases.

The repair device can include a user interface to allow an operator to, e.g., operate the repair device and/or read out data.

The repair device can include a computer unit configured to cause the repair device to perform one or more of the methods described herein, based at least in part on an execution of an appropriate computer program.

The repair device can also repair other types of objects having integrated circuit patterns, such as reticles and wafers.

In some implementations, the information about the defects serve as feedback to improve the process parameters of the manufacturing process, e.g., exposure time, focus, illumination, etc., For example, after the defects are identified from a first photolithography mask or first batch of photolithography masks, the process parameters of the manufacturing process are adjusted to reduce defects in a second mask or a second batch of masks.

In some implementations, the data analysis device 60 can include one or more computers that include one or more data processors configured to execute one or more programs that include a plurality of instructions according to the principles described above. Each data processor can include one or more processor cores, and each processor core can include logic circuitry for processing data. For example, a data processor can include an arithmetic and logic unit (ALU), a control unit, and various registers. Each data processor can include cache memory. Each data processor can include a system-on-chip (SoC) that includes multiple processor cores, random access memory, graphics processing units, one or more controllers, and one or more communication modules. Each data processor can include millions or billions of transistors.

The methods described in this document can be carried out using one or more computing devices, which can include one or more data processors for processing data, one or more storage devices for storing data, and/or one or more computer programs including instructions that when executed by the one or more computing devices cause the one or more computing devices to carry out the method steps or processing steps. The one or more computing devices can include one or more input devices, such as a keyboard, a mouse, a touchpad, and/or a voice command input module, and one or more output devices, such as a display, and/or an audio speaker.

In some implementations, the one or more computing devices can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment,” “according to an example” or “according to an aspect” in various places throughout this specification are not necessarily all referring to the same embodiment, example or aspect, but may refer to different embodiments. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

The invention can be described by the following clauses:

1. A method 26 for image enhancement comprising:
Acquiring an imaging dataset 22 of an object 58 comprising integrated circuit patterns using an imaging system 56;
Obtaining a reference dataset 30 corresponding to the acquired imaging dataset 22; and
Generating an enhanced imaging dataset 38 by filtering the acquired imaging dataset 22 with one or more learned filters 36, wherein the one or more learned filters 36 are obtained by solving an optimization problem comprising the deviation of the enhanced imaging dataset 38 from the reference dataset 30.
   2. The method of clause 1, further comprising detecting defects 24 in the acquired imaging dataset 22 by comparing the enhanced imaging dataset 38 to the reference dataset 30.
   3. A method 26 for image enhancement comprising:
Acquiring an imaging dataset 22 of an object 58 comprising integrated circuit patterns using an imaging system 56;
Obtaining a reference dataset 30 corresponding to the acquired imaging dataset 22; and
Generating an enhanced imaging dataset 38 by filtering the reference dataset 30 with one or more learned filters 36, wherein the one or more learned filters 36 are obtained by solving an optimization problem comprising the deviation of the filtered reference dataset from the imaging dataset 22.
   4. The method of clause 3, further comprising detecting defects 24 in the acquired imaging dataset 22 by comparing the enhanced imaging dataset 38 to the imaging dataset 22.
   5. The method of any one of the preceding clauses, wherein at least one of the one or more learned filters 36 is a linear filter.
   6. The method of any one of the preceding clauses, wherein at least one of the one or more learned filters 36 is a translation invariant filter.
   7. The method of any one of the preceding clauses, wherein at least one of the one or more learned filters 36 is a finite impulse response filter.
   8. The method of any one of the preceding clauses, wherein at least one of the one or more learned filters 36 is a linear, translation invariant and finite impulse response filter.
   9. The method of any one of the preceding clauses, wherein the at least one learned filter is applied by use of convolution.
   10. The method of any one of the preceding clauses, wherein a single learned filter 36 is applied.
   11. The method of any one of the preceding clauses, wherein one or more assumptions are imposed on one or more of the learned filters 36 in the optimization problem, and wherein the reference dataset 30 is identical to the imaging dataset 22.
   12. The method of any one of the preceding clauses, wherein the one or more learned filters 36 are obtained by training a machine learning model.
   13. The method of clause 12, wherein the machine learning model operates on patches.
   14. The method of clause 13, wherein the machine learning model learns a lower dimensional subspace of the patches, wherein the reference dataset 30 is identical to the imaging dataset 22, and wherein the one or more learned filters 36 represent the projection operation into the subspace and back to a patch space.
   15. The method of clause 12 or 13, wherein the machine learning model comprises a neural network and uses the weights and/or activation functions of one or more layers of the neural network as one or more learned filters 36.
   16. The method of any one of the preceding clauses, wherein the optimization problem comprises the deviation of further enhanced imaging datasets 38 from corresponding reference datasets 30, and wherein the further enhanced imaging datasets 38 are generated by applying the one or more learned filters 36 to further imaging datasets 22.
   17. The method of any one of the preceding clauses, wherein the optimization problem comprises the deviation of further filtered reference datasets from further imaging datasets 22, and wherein the further filtered reference datasets are generated by applying the one or more learned filters 36 to further reference datasets 30.
   18. The method of any one of the preceding clauses, wherein the deviation in the optimization problem is measured by the Huber loss function.
   19. The method of any one of the preceding clauses, wherein the optimization problem is solved using robust regression.
   20. The method of any one of the preceding clauses, wherein the one or more learned filters 36 reduce deviations of the imaging dataset 22 from the reference dataset 30 caused by imaging artifacts due to systematic deviations caused by the imaging system 56.
   21. The method of clause 20, wherein the systematic deviations comprise at least one of shifts, defocus, aberrations, time-delayed integration blur, wave front errors, or thermal drift.
   22. A method for image enhancement comprising:
Acquiring an imaging dataset 22 of an object 58 comprising integrated circuit patterns using an imaging system 56;
Obtaining a reference dataset 30 corresponding to the imaging dataset 22;
One or more iterations comprising the following steps:
   Obtaining a subset of the imaging dataset 22 and a corresponding subset of the corresponding reference dataset 30; and
   Applying a method 26 of any one of clauses 1 to 21 to the subset of the imaging dataset 22 and the corresponding subset of the corresponding reference dataset 30,
wherein in at least one iteration one or more learned filters 36 obtained in any of the previous steps are used as initial value for the one or more learned filters 36 to be optimized in the optimization problem; and
Combining the enhanced subsets of the imaging dataset 22 to obtain an enhanced imaging dataset 38.
   23. A method for defect detection comprising:
Acquiring an imaging dataset 22 of an object 58 comprising integrated circuit patterns using an imaging system 56;
Obtaining a reference dataset 30 corresponding to the imaging dataset 22;
One or more iterations comprising the following steps:
   Obtaining a subset of the imaging dataset 22 and a corresponding subset of the corresponding reference dataset 30; and
   Applying the method 26 of clause 2 or 4 to the subset of the imaging dataset 22 and the corresponding subset of the corresponding reference dataset 30 to detect defects 24,
wherein in at least one iteration one or more learned filters 36 obtained in any of the previous steps are used as initial value for the one or more learned filters 36 to be optimized in the optimization problem; and
Combining the detected defects 24 to obtain a defect detection in the imaging dataset 22.
   24. A computer program comprising instructions which, when the program is executed by a computer, cause the computer to carry out a method of any one of clauses 1 to 23.
   25. A computer-readable medium, on which a computer program executable by a computing device is stored, the computer program comprising code for executing a method of any one of clauses 1 to 23.
   26. A system 54 for image enhancement comprising
an imaging system 56 configured to provide an imaging dataset 22 of an object 58 comprising integrated circuit patterns;
one or more processing devices 62; and
one or more machine-readable hardware storage devices 64 comprising instructions that are executable by one or more processing devices 62 for executing any one of the methods of clauses 1 to 21.
   27. A system 54 for defect detection comprising
an imaging system 56 configured to provide an imaging dataset 22 of an object 58 comprising integrated circuit patterns;
one or more processing devices 62; and
one or more machine-readable hardware storage devices 64 comprising instructions that are executable by one or more processing devices 62 for executing the method of clause 2 or 4.
   28. A method comprising:
detecting at least one defect in an object using the method for defect detection of any of clauses 2, 4, and 23; and modifying the object to at least one of reduce, repair, or remove the at least one defect.
   29. The method of clause Error! Reference source not found. wherein the object comprises at least one of a photolithographic mask, a reticle, or a wafer.
   30. The method of clause Error! Reference source not found. or 29 wherein modifying the object comprises at least one of (i) depositing one or more materials onto the object, (ii) removing one or more materials from the object, or (iii) locally modifying a property of the object.
   31. The method of clause 30 wherein locally modifying a property of the object comprises writing one or more pixels on the object to locally modify at least one of a density, a refractive index, a transparency, or a reflectivity of the object.
   32. A method comprising:
processing a first object using a manufacturing process that comprises at least one process parameter;
detecting at least one defect in the first object using the method for defect detection of any one of clauses 2, 4, and 23; and
modifying the manufacturing process based on information about the at least one defect in the first object that has been detected to reduce the number of defects or eliminate defects in a second object to be produced by the manufacturing process.
   33. The method of clause 32 wherein the object comprises at least one of a photolithographic mask, a reticle, or a wafer.
   34. The method of clause 32 or 33 wherein modifying the manufacturing process comprises modifying at least one of an exposure time, focus, or illumination of the manufacturing process.
   35. A method comprising:
processing a plurality of regions on a first object using a manufacturing process that comprises at least one process parameter, wherein different regions are processed using different process parameter values;
applying the method for defect detection of any one of clauses 2, 4, and 23 to each of the regions to obtain information about zero or more defects in the region; identifying, using a quality criterion or criteria, a first region among the regions based on information about the zero or more defects;
identifying a first set of process parameter values that was used to process the first region; and
applying the manufacturing process with the first set of process parameter values to process a second object.
   36. The method of clause 35 wherein the object comprises a photolithographic mask, a reticle, or a wafer, and the regions comprise dies on the mask, reticle, or wafer.
   37. The method of clause 2, further comprising generating a difference dataset between the enhanced imaging dataset 38 and the reference dataset 30,
comparing the difference dataset to a threshold value, and
detecting the defects upon identifying values in the difference dataset that are greater than the threshold value.
   38. The method of clause 4, further comprising generating a difference dataset between the enhanced imaging dataset 38 and the imaging dataset 22,
comparing the difference dataset to a threshold value, and
detecting the defects upon identifying values in the difference dataset that are greater than the threshold value.

In summary, in one aspect, the invention relates to a method for defect detection comprising: acquiring an imaging dataset 22 of an object comprising integrated circuit patterns using an imaging system; obtaining a reference dataset corresponding to the acquired imaging dataset 22; generating an enhanced imaging dataset 38 by filtering the acquired imaging dataset 22 with one or more learned filters 36, wherein the one or more learned filters 36 are obtained by solving an optimization problem comprising the deviation of the enhanced imaging dataset 38 from the reference dataset 30; and detecting defects 24 in the acquired imaging dataset 22 by comparing the enhanced imaging dataset 38 to the corresponding reference dataset. The invention also relates to a corresponding computer program, a computer-readable medium and a system for defect detection in objects comprising integrated circuit patterns.

### REFERENCE NUMBER LIST

10, 10′ Photolithography system
12 Light source
14 Photolithography mask
16 Illumination optics
18 Projection optics
20 Wafer
22 Imaging dataset
24 Defect
26 Method
28 Design
30 Reference dataset
32 Difference image
34 Shift corrected difference image
36 Learned filter
38 Enhanced imaging dataset
40 Difference image
42 Horizontal axis
44 Vertical axis
46 Mean squared error
48 Mean absolute error
50 Method
52 Iteration
54 System
56 Imaging system
58 Object
60 Data analysis device
62 Processing device
64 Hardware storage device
66 Interface

What is claimed is:

1. A method for image enhancement comprising:
acquiring an imaging dataset of an object comprising integrated circuit patterns using an imaging system;
obtaining a reference dataset corresponding to the acquired imaging dataset; and
generating an enhanced imaging dataset by filtering the acquired imaging dataset with one or more learned filters, wherein the one or more learned filters are obtained by solving an optimization problem comprising the deviation of the enhanced imaging dataset from the reference dataset.

2. The method of claim 1, further comprising detecting defects in the acquired imaging dataset by comparing the enhanced imaging dataset to the reference dataset.

3. A method for image enhancement comprising:
acquiring an imaging dataset of an object comprising integrated circuit patterns using an imaging system;
obtaining a reference dataset corresponding to the acquired imaging dataset; and
generating an enhanced imaging dataset by filtering the reference dataset with one or more learned filters, wherein the one or more learned filters are obtained by solving an optimization problem comprising the deviation of the filtered reference dataset from the imaging dataset.

4. The method of claim 3, further comprising detecting defects in the acquired imaging dataset by comparing the enhanced imaging dataset to the imaging dataset.

5. The method of claim 1, wherein at least one of the one or more learned filters is a linear filter.

6. The method of claim 1, wherein at least one of the one or more learned filters is a translation invariant filter.

7. The method of claim 1, wherein at least one of the one or more learned filters is a finite impulse response filter.

8. The method of claim 1, wherein at least one of the one or more learned filters is a linear, translation invariant and finite impulse response filter.

9. The method of claim 1, wherein the at least one learned filter is applied by use of convolution.

10. The method of claim 1, wherein a single learned filter is applied.

11. The method of claim 1, wherein one or more assumptions are imposed on one or more of the learned filters in the optimization problem, and wherein the reference dataset is identical to the imaging dataset.

12. The method of claim 1, wherein the one or more learned filters are obtained by training a machine learning model.

13. The method of claim 12, wherein the machine learning model operates on patches.

14. The method of claim 13, wherein the machine learning model learns a lower dimensional subspace of the patches, wherein the reference dataset is identical to the imaging dataset, and wherein the one or more learned filters represent the projection operation into the subspace and back to a patch space.

15. The method of claim 12, wherein the machine learning model comprises a neural network and uses the weights and/or activation functions of one or more layers of the neural network as one or more learned filters.

16. The method of claim 1, wherein the optimization problem comprises the deviation of further enhanced imaging datasets from corresponding reference datasets, and wherein the further enhanced imaging datasets are generated by applying the one or more learned filters to further imaging datasets.

17. The method of claim 1, wherein the optimization problem comprises the deviation of further filtered reference datasets from further imaging datasets, and wherein the further filtered reference datasets are generated by applying the one or more learned filters to further reference datasets.

18. The method of claim 1, wherein the deviation in the optimization problem is measured by the Huber loss function.

19. The method of claim 1, wherein the optimization problem is solved using robust regression.

20. The method of claim 1, wherein the one or more learned filters reduce deviations of the imaging dataset from the reference dataset caused by imaging artifacts due to systematic deviations caused by the imaging system.

21. The method of claim 20, wherein the systematic deviations comprise at least one of shifts, defocus, aberrations, time-delayed integration blur, wave front errors, or thermal drift.

22. A method for image enhancement comprising:
acquiring an imaging dataset of an object comprising integrated circuit patterns using an imaging system;
obtaining a reference dataset corresponding to the imaging dataset;
one or more iterations comprising the following steps:
obtaining a subset of the imaging dataset and a corresponding subset of the corresponding reference dataset; and
applying the method of claim 1 to the subset of the imaging dataset and the corresponding subset of the corresponding reference dataset,
wherein in at least one iteration one or more learned filters obtained in any of the previous steps are used as initial value for the one or more learned filters to be optimized in the optimization problem; and
combining the enhanced subsets of the imaging dataset to obtain an enhanced imaging dataset.

23. A method for defect detection comprising:
acquiring an imaging dataset of an object comprising integrated circuit patterns using an imaging system;
obtaining a reference dataset corresponding to the imaging dataset;
one or more iterations comprising the following steps:
obtaining a subset of the imaging dataset and a corresponding subset of the corresponding reference dataset; and
applying the method of claim 2 to the subset of the imaging dataset and the corresponding subset of the corresponding reference dataset to detect defects,
wherein in at least one iteration one or more learned filters obtained in any of the previous steps are used as initial value for the one or more learned filters to be optimized in the optimization problem; and
combining the detected defects to obtain a defect detection in the imaging dataset.

24. A computer program comprising instructions which, when the program is executed by a computer, cause the computer to carry out the method of claim 1.

25. A computer-readable medium, on which a computer program executable by a computing device is stored, the computer program comprising code for executing the method of claim 1.

26. A system for image enhancement comprising
an imaging system configured to provide an imaging dataset of an object comprising integrated circuit patterns;
one or more processing devices; and
one or more machine-readable hardware storage devices comprising instructions that are executable by the one or more processing devices for executing the method of claim 1.

27. A system for defect detection comprising
an imaging system configured to provide an imaging dataset of an object comprising integrated circuit patterns;
one or more processing devices; and
one or more machine-readable hardware storage devices comprising instructions that are executable by the one or more processing devices for executing the method of claim 2.
